(19) United States
(12) Patent Application Publication
(10) Pub. No.: US 2025/0012889 A1
(43) Pub. Date: Jan. 9, 2025

(54) A COMMUNICATION, SAFETY, AND LOCATION SYSTEM FOR USE AS PART OF A GOODS TRANSPORTING SYSTEM

(71) Applicant: THARSUS LIMITED, Northumberland (GB)

(72) Inventors: David SWAN, East Boldon (GB); Brian PALMER, Stocksfield (GB); Craig ROBINSON, Durham (GB)

(21) Appl. No.: 18/708,544

(22) PCT Filed: Nov. 8, 2022
(86) PCT No.: PCT/IB2022/060747

§ 371 Date: May 8, 2024

(30) Foreign Application Priority Data
Nov. 9, 2021 (GB) 2116067.6

(51) Int. Cl. G01S 5/02

(52) U.S. Cl. CPC G01S 5/021; G01S 2205/001

(57) ABSTRACT

A communication, safety, and location system for use as part of a goods transporting system comprises a plurality of tile units 2, the tile units 2 configured to tesselate to form a substantially continuous grid with a substantially flat upper surface and to enable movement of cargo carrying units positioned on the surface in use; a number of the tile units at locations spaced within the grid equipped with UWB transceivers.

### FIELD

The present invention relates to a communication, safety and location system for use as part of a goods transporting system. More particularly, the present invention relates to a communication, safety and location system for use as part of a goods transporting system that uses Ultra Wide Band Radio transmission and receiving to communicate and locate personnel and objects within a goods transporting system.

### BACKGROUND

With improvements in recording the exact location of stock in a storage area, and improved transport and logistics services, it has become more common for suppliers to centralise their warehousing and distribution centres, to store a wider range of goods within a larger, centralised premises, and to ‘pick’ items from the larger stockpile for distribution from the centralised storage area or facility as required. This has led to the rise of ‘just in time’ manufacturing and supply chains.

In older, known warehouses or storage/processing facilities, goods are processed in a roughly linear fashion. Inwards deliveries are unpacked into crates; the loaded crates are placed onto conveyors; and the conveyors carry the loaded crates to shelves, where human “pickers” then take what they need, in order to fill customers' orders.

It is common for goods to be stored and moved in cages or on pallets. As location and item tracking on larger scales becomes more straightforward, it is becoming more common to use the floorspace of warehouses and/or storage/processing facilities in a combined manner, as both storage and transport. A number of automated movement solutions are known that assist with increasing throughput, reducing the amount of floor space used for storing and transporting a particular volume of goods, and which provide increased agility and significantly reduce labour requirements.

For example, WO2019/084457 describes and shows an automated carrier system for moving objects to be processed. The automated carrier system comprises a plurality of sections laid end-to-end and side-by-side to form a grid, and an automated carrier that moves on top of the track sections.

WO2019/175195 describes and shows a similar system where conveying modules move on a base grid.

The grids or carrier systems used for these systems can be formed from a number of separate grid elements laid directly adjacent to one another, in a pattern large enough to cover a considerable area of the floor space of a warehouse, with large numbers of cargo carrier units active and moving on top of the grid elements within the perimeter of the grid, carrying cargo trolleys, crates or similar. In order to control the system and for this to work effectively, the individual grid elements need to communicate at least with a control system hub, and preferably also with other elements of the system (i.e. with each other). This is usually achieved via hardwiring/field wiring between the elements.

Using a system such as CAN Bus as an example, once each grid element is in position, it is then possible to connect tiles on two separate CAN Bus(es)—a column bus and a row bus. If the CAN Bus controller for each Bus then broadcasts its identifier, a tile can self-address by receiving these broadcasts and forming its row/column identification. The overall control system can then relate the row/column identification to a physical location (a physical row/column address), and so ensure that the correct command is delivered to the correct tile at the required/correct time.

However, field wiring introduces two fundamental problems: the amount of cabling required (which can total thousands of metres), and the complexity of managing multiple discrete data-buses (which can number several hundred in a typical installation). Depending on the particular technology used, there can also be issues with managing bus node failures, and in replacing tiles for maintenance purposes. Removing and replacing fully hardwired elements can be complex and time-consuming.

Further, the CAN Bus approach described above for self-addressing of tiles does not work in a general wireless system. There is no physical connection or relation that can guarantee that a signal transmitted wirelessly is only delivered to the tiles on a particular bus.

it is also necessary for the location of the cargo carrying units to be monitored or otherwise known. As these move, these cannot be hardwired, and a general wireless system is also unsuitable as outlined above. It is also often necessary for personnel to enter the grid (i.e. to walk on top of it, inside the perimeter of the grid) in order to carry out routine maintenance on certain areas or within certain boundaries, to replace or remove faulty carrier units, to add or remove cargo from units, etc. It is usually uneconomical and inefficient to shut down the entire operation when these operations are taking place. The personnel are therefore required to enter an active working area that has large and heavy equipment moving within it, and the safety of the personnel is therefore a primary concern. It is necessary to maintain the safety of personnel working within the perimeter of the grid, while also enabling normal operations such as monitoring and moving the cargo carrying units.

While physical barriers can be used to prevent access to the main grid, or to isolate a particular section or divide the grid into sub-grids, using physical barriers adds to the resource required for day-to-day operation, reduces the flexibility of the operation of the grid, and adds to the work required if reconfiguration of the dangerous area is necessary. It can also be difficult or impractical to install physical barriers in some locations. Light curtains and LIDAR scanners are common examples of presence detecting safety interlocks. However, integrating these into the operation of the system or running them in parallel can add to the complexity and decrease operational flexibility.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### SUMMARY

It is an object of the present invention to provide a communication, safety and location system which goes some way to overcoming the abovementioned disadvantages or which at least provides the public or industry with a useful choice.

The term “comprising” as used in this specification and indicative independent claims means “consisting at least in part of”. When interpreting each statement in this specification and indicative independent claims that includes the term “comprising”, features other than that or those prefaced by the term may also be present. Related terms such as “comprise” and “comprises” are to be interpreted in the same manner.

As used herein the term “and/or” means “and” or “or”, or both.

As used herein “(s)” following a noun means the plural and/or singular forms of the noun.

Accordingly, in a first aspect the present invention may broadly be said to consist in a communication, safety, and location system for use as part of a goods transporting system, comprising: a plurality of tile units, the tile units configured to tesselate to form a substantially continuous grid with a substantially flat upper surface and to enable the movement of cargo carrying units positioned on the surface in use; a number of the tile units at locations spaced within the grid equipped with UWB transceivers; a number of the tile units at locations spaced within the grid equipped with UWB transceivers.

In an embodiment, the UWB transceivers are configured and controlled so that their UWB transmissions have short on-air transmission times or pulses.

In an embodiment, the UWB transceivers are configured and controlled so that transmission times are no longer than substantially two nanoseconds.

In an embodiment, the UWB transceivers are configured and controlled so that their UWB transmissions occupy a wide frequency band.

In an embodiment, the UWB transceivers are configured to broadcast across a range of frequencies having a bandwidth of substantially 500 MHz.

In an embodiment, the UWB transceivers are configured to broadcast across a range of frequencies having fractional bandwidths greater than 20%.

In an embodiment, the Power Spectral Density of the UWB transceivers is limited to a maximum of substantially 41.3 dBm/MHz.

In an embodiment, the communication, safety, and location system further comprises a number of cargo carrier units configured to carry loads thereon, the tiles and cargo carrier units mutually configured so that the cargo carrier units move on top of the tiles in use, the cargo carrier units also equipped with UWB transceivers.

In an embodiment, the cargo carrier units are configured to carry a cargo of substantially up to 1000 Kg.

In an embodiment, the communication, safety, and location system further comprises a control system, the control system configured to receive signals from the UWB transceivers, to convert these into positional data, and to transmit instructions to the tile units relating to movement of cargo carrying units positioned on the tile units.

In an embodiment, the control system is at least partly distributed throughout the tile units.

In an embodiment, the control system is at least partly remotely located from and separate to the tile units.

In an embodiment, the communication, safety, and location system further comprises portable UWB transceivers adapted to be carried by individuals, the control system configured to receive signals from the portable UWB transceivers, and to transmit instructions to the tile units relating to movement of cargo carrying units so that an exclusion zone is created around any individual on the grid who is carrying a portable UWB transceivers.

In an embodiment, the grid is at least partly enclosed by a safety barrier, closeable openings in the safety barrier configured to allow access to the grid, the openings controlled by the control system, the control system configured to open the openings when a portable UWB transceiver is detected at or close to the opening.

In a second aspect the present invention may broadly be said to consist in a communication, safety, and location system, comprising: a plurality of AGVs configured to operate within a storage space having multiple aisles, each of the AGVs comprising a UWB transceiver, and; a control system configured to receive signals from the UWB transceivers, to convert these into positional data, and to transmit instructions to the AGVs relating to movement of the AGVs.

In an embodiment, the UWB transceivers are configured and controlled so that their UWB transmissions have short on-air transmission times or pulses.

In an embodiment, the UWB transceivers are configured and controlled so that transmission times are no longer than substantially two nanoseconds.

In an embodiment, the UWB transceivers are configured and controlled so that their UWB transmissions occupy a wide frequency band.

In an embodiment, the UWB transceivers are configured to broadcast across a range of frequencies having a bandwidth of substantially 500 MHz.

In an embodiment, the UWB transceivers are configured to broadcast across a range of frequencies having fractional bandwidths greater than 20%.

In an embodiment, the Power Spectral Density of the UWB transceivers is limited to a maximum of substantially 41.3 dBm/MHz.

In an embodiment, the communication, safety, and location system further comprises a control system, the control system configured to receive signals from the UWB transceivers, to convert these into positional data, and to transmit instructions to the AGVs relating to movement within an operational space.

In an embodiment, the control system is distributed throughout the AGVs.

In an embodiment, the control system is remotely located from and separate to the AGVs.

In a third aspect the present invention may broadly be said to consist in a static machine safety system comprising: at least one machine UWB transceiver located in or on the machine; a control system configured to receive signals from the at least one machine UWB transceiver, and from a portable UWB transceiver or transceivers carried by a machine operator in use; the control system configured to cause the machine to operate or to cease operations depending on the relative positional information received from the machine UWB transceiver and the portable UWB transceiver or transceivers.

In an embodiment, the UWB transceivers are configured and controlled so that their UWB transmissions have short on-air transmission times or pulses.

In an embodiment, the UWB transceivers are configured and controlled so that transmission times are no longer than substantially two nanoseconds.

In an embodiment, the UWB transceivers are configured and controlled so that their UWB transmissions occupy a wide frequency band.

In an embodiment, the UWB transceivers are configured to broadcast across a range of frequencies having a bandwidth of substantially 500 MHz.

In an embodiment, the UWB transceivers are configured to broadcast across a range of frequencies having fractional bandwidths greater than 20%.

In an embodiment, the Power Spectral Density of the UWB transceivers is limited to a maximum of substantially 41.3 dBm/MHz.

In an embodiment, the control system is located in or on the machine.

In an embodiment, the control system is at least partly remotely located from the machine.

With respect to the above description then, it is to be realised that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE FIGURES

Further aspects of the invention will become apparent from the following description which is given by way of example only and with reference to the accompanying drawings which show an embodiment of the device by way of example, and in which:

FIG. 1 shows a perspective view from one side looking downwards of a system for transporting goods around a warehouse or similar storage and order processing facility, the system comprising a number of tiles laid out in a grid on the floor of a warehouse, and a number of skids positioned on top of the grid, the skids and tiles mutually configured so that the skids move on top of the tiles in use to and from positions as required, the skids in use carrying trolleys or similar on their upper surfaces so that as the skids move the trolly is moved to the required location on top of the skid.

FIG. 2 shows a perspective close-up view from one side looking downwards of part of the tile grid of FIG. 1, showing loaded trolleys positioned on top of skids that are being moved on the tile grid for loading and distribution on vehicles.

FIGS. 3a and 3b contrast and show the differences between the waves of a typical narrowband transmission and a typical Ultra Wide Band transmission, FIG. 3a showing a typical narrowband transmission, and FIG. 3b showing a typical Ultra Wide Band transmission, time plotted on the ‘x’ axis, and amplitude plotted on the ‘y’ axis, on both figures.

FIG. 4 shows a graphed example of an Ultra Wide Band transmission and reflected pulse, with time plotted on the ‘x’ axis and amplitude plotted on the ‘y’ axis, a dotted horizontal line across the graph showing a threshold amplitude value.

FIG. 5 shows a graphed example of how an UWB pulse can be distinguished even in a noisy environment, with time plotted on the ‘x’ axis and amplitude plotted on the ‘y’ axis, a dotted horizontal line across the graph showing a threshold amplitude value, a breakout box on the figure showing a close-up of the pulse.

### DETAILED DESCRIPTION

Embodiments of the invention, and variations thereof, will now be described in detail with reference to the figures.

### System Overview

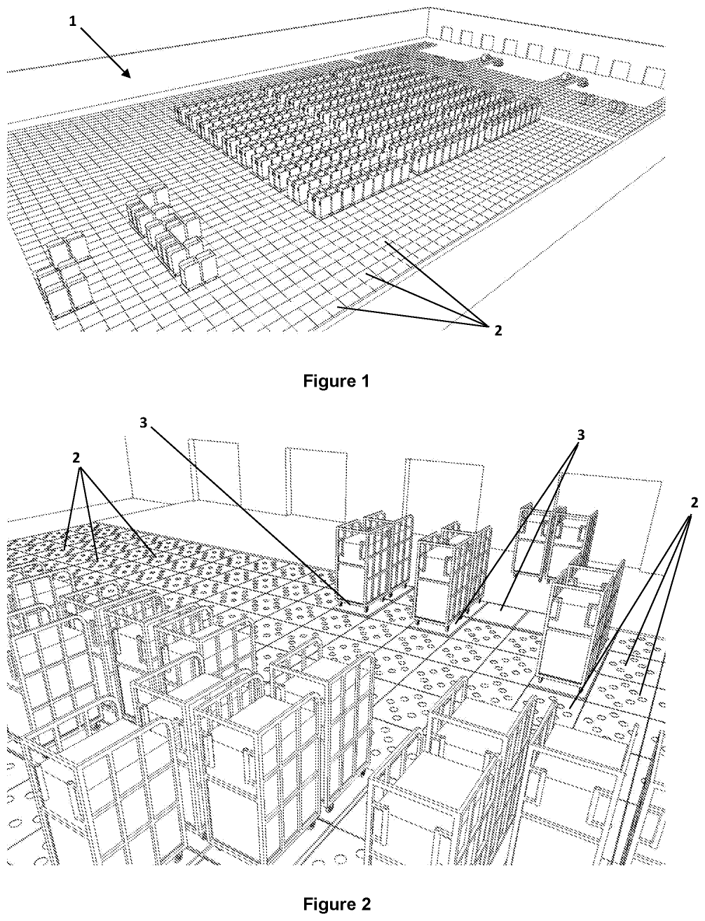

A typical system for transporting goods within a storage and order processing facility is shown in overview in FIG. 1.

As shown in FIG. 1, the system is installed within a warehouse or similar location. In this embodiment, the warehouse has a goods-inwards section at one end (to the right of the figure). Individual goods are shipped from widely-dispersed manufacturing or growing locations to the warehouse, which acts as a central node for storage and redistribution. These goods enter via the goods-inwards section.

The system 1 as shown in FIG. 1 comprises a number of tile units, generally designated with the numeral ‘2’, laid out in a grid on the floor of the warehouse. Each tile unit 2 is substantially the same size as every other, and appears square or rectangular when viewed in plan view, so when a number of the tile units 2 are located side-by-side with one another they form a grid pattern, made up of the individual squares/rectangles of each tile unit 2. That is, the tile units 2 are placed so as to tessellate (fit together closely without gaps or overlapping) on the floor of the warehouse. In a typical system of this type, the grid will cover a majority of the floor surface of a warehouse, and can consist of thousands of tiles. The individual tiles allow the grid to be laid out to any shape and size as required for a particular use, by arranging the individual tile units to form a grid of the required shape and size. The general principle is that a number of the tile units 2 are laid out in a continuous grid pattern, directly side-by-side with one another, in the shape and pattern required—that is, so that a cargo carrier unit or similar located on a particular tile unit 2 can be transported from one point or tile in the grid to another across the upper surface of the apparatus 1, via intervening tile units 2. The tiles 2 are configured to move the cargo carrier unit via directionally-adjustable wheels or similar that extend through or from the upper surface of the tile.

In use, a number of cargo carrier units are active and moving within the perimeter of the grid. In the embodiment shown, the cargo carrier units comprise skid plates 3, which are in direct contact with, and move on top of, the tile units 2. Goods trolleys 4 or similar items are positioned on top of the skid plates 3 for transport around the grid. The plates 3 are configured to receive the trolleys and transport these.

At least some and preferably all of the tile units 2 are configured so that they can communicate with a control system. The control system provides instructions to the tile units 2, and receives status updates and similar information back from the tiles 2 in return. The control system can be a discrete central control system, either remotely located, or within or directly adjacent to the grid. Alternatively, the control system can be at least partially distributed within the tile units that form the grid.

In this embodiment, the tile units 2 are configured so that they can communicate directly with other tiles 2—at least the tiles directly adjacent to themselves, and therefore form part of the distributed control system. This allows them to co-ordinate their actions with each other directly. Items on top of the grid (cargo carrier units—skid plates 3), are moved around the grid through the cooperation of multiple tiles 2 working in a coordinated manner to route items from one tile 2 to another, so that in overall operation items are moved from a source to a destination.

In order to function, the control system needs to ‘know’ where each tile 2 is within the overall grid, and from this, which tiles any particular individual tile is physically adjacent to. The control system also needs to ‘know’ what each tile is doing/what action the tile is undertaking at any particular time. The control system requires this information in order to be able to send the correct instructions to a tile, so that the tile carries out the correct action at the correct time—e.g. moving an item across its surface in a particular direction.

This means that physical tile locations and their logical tile address (for information routing purposes), must be known.

The known, prior art, approach to communication between elements within the system is usually some form of field-bus wiring, such as for example EtherCAT, Profibus, Modbus, RS485, CAN Bus etc. As outlined in the prior art section, the two main issues with field wiring are: the amount of cabling required (which can total thousands of metres), and the complexity of managing multiple discrete data-buses (which can number several hundred in a typical installation).

In the preferred embodiment of the present invention, the system uses Ultra Wide Band Radio transmission and receiving to communicate between elements of the apparatus 1, as described below.

### Communication

As outlined above, in the preferred embodiment, the tiles 2 are arranged into a grid.

In the preferred embodiment of the present invention, intra-system communication (communication between the separate elements of the system) takes place as outlined below.

Each of the parts of the system 1 that need to communicate (transmit and/or receive) are fitted with an Ultra Wide Band (UWB) transceiver. That is, in an embodiment each tile 2 is fitted with an Ultra Wide Band (UWB) transceiver.

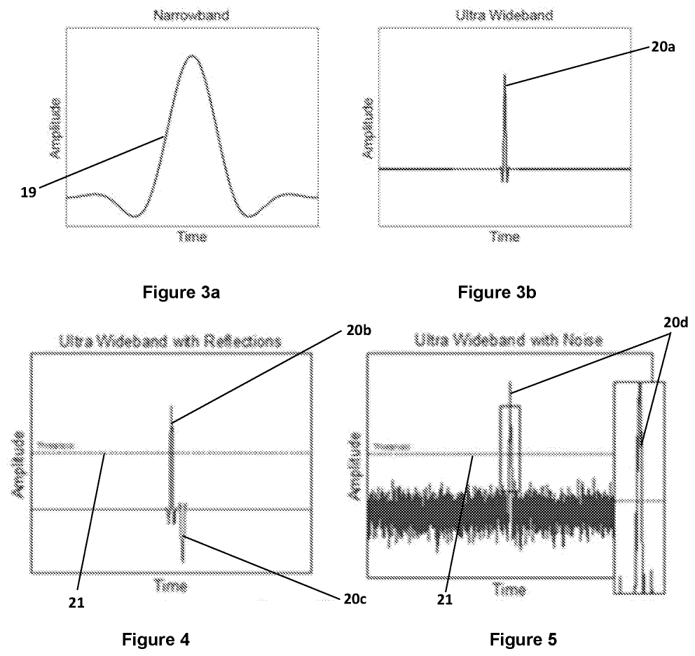

Ultra Wide Band in this context refers to signals broadcast across a wide range of frequencies. ‘Wide’ in the context of this specification should be taken as generally meaning either across a bandwidth of around 500 MHz, or fractional bandwidths greater than 20% (the absolute bandwidth divided by the centre frequency, expressed as a percentage, is greater than 20%), whichever is less. This is in contrast with, and relative to, ‘narrow’ band radio technologies such as Wi-Fi or Bluetooth that have bandwidths of the order of 1 MHz to a few 10s of MHz. FIGS. 3a and 3b show and contrast the differences between the waves of a typical narrowband transmission and a typical Ultra Wide Band transmission. FIG. 3a shows a typical narrowband transmission with the wave shown as wave 19, and FIG. 3b shows a typical Ultra Wide Band transmission, with the UWB pulse shown as pulse 20a on FIG. 3b. In each figure, time is plotted on the ‘x’ axis, and amplitude is plotted on the ‘y’ axis.

Each UWB transceiver is configured to transmit and receive these types of signals.

The UWB transceivers transmit signals that utilise a train of impulses rather than a modulated sine wave to transmit information. This characteristic makes precise ranging and positioning possible. The pulse occupies a wide frequency band, and therefore the rising edge of the pulse is very steep, as shown in FIGS. 3b, 4, and 5. This allows the receiver to very accurately measure the arrival time of the signal. In addition, the UWB transceivers are configured so that the pulses which they transmit are very narrow, no more than substantially two nanoseconds.

Due to the nature of the signals, UWB pulses can be distinguished even in noisy environments, and the signals are resistant to multipath effects. This is shown in FIG. 5, where a graphed example of how an UWB pulse 20d can be distinguished even in a noisy environment is shown. In a similar manner to FIG. 3, time is plotted on the ‘x’ axis and amplitude is plotted on the ‘y’ axis. A dotted horizontal line 21 across the graph on FIG. 5 shows a threshold amplitude value. A breakout box on FIG. 5 shows a close-up of the pulse.

Also, due to the strict spectral mask, the transmit power lies at the noise floor, which means that UWB transmissions do not interfere with other radio communication systems operating in the same frequency bands, since this just increases the overall noise floor, rather than creating interference. This allows the UWB transceivers to communicate with one another even in environments that are (in a radio-frequency sense) ‘noisy’.

As outlined above, the UWB transceivers are configured and controlled so that their UWB transmissions have short on-air transmission times or pulses. This means that the pulses can be used to measure the time-of-flight between two points (e.g. a transmitter and a receiver such as for example two spaced-apart transceivers in two spaced-apart tiles 2). This allows UWB to be used as a location tracking technology, with an achievable positional resolution of typically +/−10 cm. The time that elapses between ‘signal broadcast’ and ‘signal received’ is measured, and this provides an indication of distance. FIG. 4 shows a graphed example of an Ultra Wide Band transmission 20b and reflected pulse 20c. In a similar manner to FIG. 3 and FIG. 5, time is plotted on the ‘x’ axis and amplitude is plotted on the ‘y’ axis. A dotted horizontal line 21 across the graph on FIG. 4 shows a threshold amplitude value.

In this embodiment, the pulses have a transmission time of no more than substantially two nanoseconds. However, any transmission time/pulse that has a duration short enough to be used to measure the time-of-flight between two points can be considered to be ‘short’ enough to be suitable.

The distance measurement/calculation can be made either relative to other tiles already in the grid; relative to known fixed points in the space, or; a combination of both. From the perspective of a remotely located control system the measured/calculated location can then be related to a logical address, by comparison with a list of potential locations in the known nominal grid map.

Signals can also be triangulated—i.e. two or more receiving transceivers in different locations provide distance data, which can be used to calculate the position in the grid at the point where the lines of ‘calculated distance of the receiver from the transmitter’ intersect. It should be noted that the position of the transmitters needs to be known in order to simplify this process. However, transmitters in known or pre-set positions can be used initially, and once the position of these has been set or entered, subsequent positional calculations can be made as required.

UWB bandwidth transmissions need to restrict the power transmitted to low levels. The Power Spectral Density, defined in power per MHz, must be limited in order to restrict the potential for interference across the large spectrum used by UWB. The limit in most territories is −41.3 dBm/MHz. This, combined with the high carrier frequencies typically used, limits the effective transmission range of UWB. The transceivers of the preferred embodiment are configured to achieve this. However, as a large number of transceivers are used (in the preferred embodiment in all or substantially all of the tiles 2 and the skid plates 3) this is not a particular disadvantage.

In the preferred embodiment, the skid plates 3 can carry pallet-sized masses of up to approximately 1000 kg, and can move on the grid at speeds up to approximately 1 m/s.

For maintenance or similar (if a tile 2 and/or skid plate 3 is/are non-functional and need re-setting or replacing), the usual approach would be to deactivate all or part of the machine in a rigidly defined manner to allow safe interactions to take place. For example, if a tile in a particular row needs replacing, an entire area of the grid comprising several rows and possibly also several columns might need to be deactivated (and would therefore be unusable) until such time as the required work was completed. Further, unauthorised access to the area within which work is taking place would usually be prevented by the installation of suitable physical barriers around the area. This approach adds significant cost in safety related equipment and infrastructure; machine downtime and access must be carefully managed; and machine throughput is impacted by the enforced use of inflexible, simplistic rules governing which parts of the machine must be deactivated to create safe working zones.

In contrast, in an embodiment of the invention, any personnel entering the grid carry transceivers similar to those used in the tiles 2. These transceivers allow the location of the person carrying the transceiver to be continually monitored—their location is continually calculated/measured by having signals sent to and from the carried transceiver, the transceivers in tiles close to their location, and/or by dedicated ‘safety’ transceivers that can be set up around the grid and which are in communication with the carried transceivers and the control system (and, if required, the tiles). In this manner, a safe zone within the grid can be dynamically created in which only the required tiles limit or stop their operation, and the cargo carriers (skid plates 3 in the preferred embodiment) can be dynamically routed around the personnel and the area within which they are working. For example, maintenance personnel can walk across the grid, with their location and the location of cargo carriers around them continuously monitored. The control system will halt the travel or movement of any cargo carriers that are on collision courses with the personnel by sending instructions to the tiles 2 in that area, so that these contain or re-route the cargo carriers, rather than allowing them to continue on their original course. A dynamic ‘exclusion zone’ is created around the personnel by continually monitoring their position and operating the grid so that no movement takes place within a certain distance of the personnel. The selection of which particular tiles to use to hold the cargo carriers temporarily in position, or to re-route the cargo carrier or similar, can be made by simple control systems with a limited range of commands within the tiles themselves (using for example a zoned scheme based on criteria such as ‘range to nearby personnel’, where ‘shut down’ or ‘re-route’ commands are made based on distance from the personnel), or by the central control system assessing the grid as a whole and distributing safety related commands, or a combination of both.

In the preferred embodiment, access to the grid by personnel without appropriate safety devices can also be controlled by limiting access to the grid space at natural access points. Passing the access point (a barrier such as a door, or similar) can be limited to those with correctly working and identified safety devices on their person, with monitoring equipment at the access point noting the presence of such a device and confirming its location by measurement, as outlined above.

In other embodiments, the UWB system outlined above can also be used in warehouses that employ mobile robots, such as AGVs/AMRs. In a warehouse with multiple aisles where AGVs aid in picking operations there are many robot agents acting independently or semi-independently within the same space. AGVs have a requirement to communicate with a controlling entity, and they have a need to act in a safe manner. AGVs achieve safe operation through a combination of speed limitations (according to appropriate ISO standards, including for ISO15066:2016 for collaborative robots) and object detection through safety scanners (typically of the LIDAR type). However, limiting the speed of an AGV limits its ability to deliver outputs per hour, etc. Systems of this type usually use WiFi to communicate. However, this has disadvantages as outlined above.

A UWB system can allow higher speed operation that is still safe. UWB location-based technology the same as or similar to that described above for the cargo containers on a grid provides enhanced ‘situational awareness’ throughout the system—that is, the AGVs and the control system monitor their relative location and velocities and the movement of personnel equipped with safety equipment within an area of operations. As their awareness of the location of all the other dynamic and static elements in the system is more precise and occurs faster than can be achieved through the use of line-of-sight (LIDAR) scanners and/or wireless, this then allows the AGVs to move at higher speeds when they ‘know’ that routes are clear or that potential hazards are distant. The maximum speed of an AMR can be adjusted through knowledge of the proximity of other elements in the space—e.g. other AMRs, other non-automated equipment, personnel equipped with UWB transceivers, and pre-mapped locations.

If the system is configured at a high enough safety performance level then other functionality can be built into the system that relies upon that guaranteed performance level. For example, the ability to provide a (sub-)system wide wireless emergency-stop function whereby the emergency stop instruction is distributed and/or derived from devices interconnected by UWB transceivers.

The system described above can also be used for static machine safety. Many industrial machines operate from a single static location, but contain hazardous moving parts or are hazardous in operation. For example, lathes, forging presses and similar are static, but contain parts that move at high-velocity when operating. Acid baths or similar are static, but contain chemicals that are hazardous if not handled correctly.

For safety purposes, it is necessary for the operation of a potentially dangerous static machine to be prevented in the presence of personnel or items that could impede the operation of the machine or cause a hazard during operation

The usual, known, prior art solution is to either provide a physical barrier to prevent access to the dangerous area, or to provide a system of machine interlocks such that operation is prevented when a barrier is not present, or an operator has not indicated dynamically that operation can take place (by using each hand to press two distinct and separate buttons, for example). Light curtains and LIDAR scanners are common examples of presence detecting safety interlocks. Radio frequency safety devices are also known, an example being a device that operates as a near-field presence detector for conveyor belt deactivation.

A UWB system similar to that described above can be used in these circumstances. The location of personnel can be monitored by the control system, such that intrusion into defined volumetric zones can be monitored and operation of the machines and apparatus in those zones inhibited when necessary. This would potentially allow: the removal of physical barriers; flexible access to equipment in different phases of its operation; the enhancement of the level of human-machine interaction whilst maintaining safe practices; the reduction of the overall cost of safety equipment, and; the provision of new ways of working that aim to improve efficiency.

1. A communication, safety, and location system for use as part of a goods transporting system, comprising:
a plurality of tile units, the tile unit configured to tesselate to form a substantially continuous grid with a substantially flat upper surface and to enable movement of cargo carrying units positioned on the surface in use;
a number of the tile units at locations spaced within the grid equipped with UWB transceivers.

2. A communication, safety, and location system as claimed in claim 1, wherein the UWB transceivers are configured and controlled so that their UWB transmissions have short on-air transmission times or pulses.

3. A communication, safety, and location system as claimed in claim 2, wherein the UWB transceivers are configured and controlled so that transmission times are no longer than substantially two nanoseconds.

4. A communication, safety, and location system as claimed in claim 1, wherein the UWB transceivers are configured and controlled so that their UWB transmissions occupy a wide frequency band.

5. A communication, safety, and location system as claimed in claim 1, wherein the UWB transceivers are configured to broadcast across a range of frequencies having a bandwidth of substantially 500 MHz.

6. A communication, safety, and location system as claimed in claim 1, wherein the UWB transceivers are configured to broadcast across a range of frequencies having fractional bandwidths greater than 20%.

7. A communication, safety, and location system as claimed in claim 1, wherein the Power Spectral Density of the UWB transceivers is limited to a maximum of substantially 41.3 dBm/MHz.

8. A communication, safety, and location system as claimed in claim 1, further comprising a number of cargo carrier units configured to carry loads thereon, the tiles and cargo carrier units mutually configured so that the cargo carrier units move on top of the tiles in use, the cargo carrier units also equipped with UWB transceivers.

9. A communication, safety, and location system as claimed in claim 8, wherein the cargo carrier units are configured to carry a cargo of substantially up to 1000 Kg.

10. A communication, safety, and location system as claimed in claim 1, further comprising a control system, the control system configured to receive signals from the UWB transceivers, to convert these into positional data, and to transmit instructions to the tile units relating to movement of cargo carrying units positioned on the tile units.

11. A communication, safety, and location system as claimed in claim 10, wherein the control system is at least partly distributed throughout the tile units.

12. A communication, safety, and location system as claimed in claim 10, wherein the control system is at least partly remotely located from and separate to the tile units.

13. A communication, safety, and location system as claimed in claim 10, further comprising portable UWB transceivers adapted to be carried by individuals, the control system configured to receive signals from the portable UWB transceivers, and to transmit instructions to the tile units relating to movement of cargo carrying units so that an exclusion zone is created around any individual on the grid who is carrying a portable UWB transceivers.

14. A communication, safety, and location system as claimed in claim 13, wherein the grid is at least partly enclosed by a safety barrier, closeable openings in the safety barrier configured to allow access to the grid, the openings controlled by the control system, the control system configured to open the openings when a portable UWB transceiver is detected at or closed to the opening.

15. A communication, safety, and location system, comprising:
a plurality of AGVs configured to operate within a storage space having multiple aisles, each of the AGVs comprising a UWB transceiver;
a control system configured to receive signals from the UWB transceivers, to convert these into positional data, and to transmit instructions to the AGVs relating to movement of the AGVs.

16. A communication, safety, and location system as claimed in claim 15, wherein the UWB transceivers are configured and controlled so that their UWB transmissions have short on-air transmission times or pulses.

17. A communication, safety, and location system as claimed in claim 16, wherein the UWB transceivers are configured and controlled so that transmission times are no longer than substantially two nanoseconds.

18. A communication, safety, and location system as claimed in claim 15, wherein the UWB transceivers are configured and controlled to that their UWB transmissions occupy a wide frequency band.

19. A communication, safety, and location system as claimed in claim 15, wherein the UWB transceivers are configured to broadcast across a range of frequencies having a bandwidth of substantially 500 MHz.

20. A communication, safety, and location system as claimed in claim 15, wherein the UWB transceivers are configured to broadcast across a range of frequencies having fractional bandwidths greater than 20%.

21. A communication, safety, and location system as claimed in claim 15, wherein the Power Spectral Density of the UWB transceivers is limited to a maximum of substantially 41.3 dBm/MHz.

22. A communication, safety, and location system as claimed in claim 15, further comprising a control system, the control system configured to receive signals from the UWB transceivers, to convert these into positional data, and to transmit instructions to the AGVs relating to movement within an operational space.

23. A communication, safety, and location system as claimed in claim 22, wherein the control system is distributed throughout the AGVs.

24. A communication, safety, and location system as claimed in claim 22, wherein the control system is remotely located from and separate to the AGVs.

25. A static machine safety system, comprising:
at least one machine UWB transceiver located in or on the machine;
a control system configured to receive signals from the at least one machine UWB transceiver, and from a portable UWB transceiver or transceivers carried by a machine operator in use;
the control system configured to cause the machine to operate or to cease operations depending on the relative positional information received from the machine UWB transceiver and the portable UWB transceiver or transceivers.

26. A communication, safety, and location system as claimed in claim 25, wherein the UWB transceivers are configured and controlled so that their UWB transmissions have short on-air transmission times or pulses.

27. A communication, safety, and location system as claimed in claim 26, wherein the UWB transceivers are configured and controlled so that transmission times are no longer than substantially two nanoseconds.

28. A communication, safety, and location system as claimed in claim 25, wherein the UWB transceivers are configured and controlled so that their UWB transmissions occupy a wide frequency band.

29. A communication, safety, and location system as claimed in claim 25, wherein the UWB transceivers are configured to broadcast across a range of frequencies having a bandwidth of substantially 500 MHz.

30. A communication, safety, and location system as claimed in claim 25, wherein the UWB transceivers are configured to broadcast across a range of frequencies having fractional bandwidths greater than 20%.

31. A communication, safety, and location system as claimed in claim 25, wherein the Power Spectral Density of the UWB transceivers is limited to a maximum of substantially 41.3 dBm/MHz.

32. A communication, safety, and location system as claimed in claim 25, wherein the control system is located in or on the machine.

33. A communication, safety, and location system as claimed in claim 25, wherein the control system is at least partly remotely located from the machine.
